(19) United States
(12) Patent Application Publication
(10) Pub. No.: US 2025/0022320 A1
(43) Pub. Date: Jan. 16, 2025

(54) MACHINE LEARNING AND MANAGEMENT OF BIOMETRIC DATA

(71) Applicant: eConnect, Inc., Las Vegas, NV (US)

(72) Inventors: Jeremiah Morrill, Somers, MT (US); James Pooton, Kalispell, MT (US); Travis Whidden, Las Vegas, NV (US)

(21) Appl. No.: 18/587,917

(22) Filed: Feb. 26, 2024

Related U.S. Application Data
(60) Provisional application No. 63/486,877, filed on Feb. 24, 2023.

(51) Int. Cl. G06V 40/50; G06V 10/74; G06V 40/16

(52) U.S. Cl. CPC G06V 40/50; G06V 10/761; G06V 40/172

(57) ABSTRACT

Technologies and implementations for facilitating machine learning of processing and management of biometric matching. The technologies and implementations may include a biometric matching module (BMM). The BMM may facilitate converting biometric digital data into embeddings, and prior to determining a match (i.e., biometric recognition), the BMM may move embeddings to memory or memory pools close to one or more processors.

### RELATED APPLICATION

This application claims benefit of priority to U.S. Provisional Patent Application Ser. No. 63/486,877, filed Feb. 24, 2023, titled MACHINE LEARNING AND MANAGEMENT OF BIOMETRIC DATA, which is incorporated herein by reference in its entirety for all purposes.

### BACKGROUND

Unless otherwise indicated herein, the approaches described in this section are not prior art to the claims in this application and are not admitted to be prior art by inclusion in this section.

Processing and management of data in real time may be difficult. For example, technology related to biometric analysis may include large numbers of data to be processed and managed. An example of biometric analysis, which may include a large number of data to be processed and managed, may include, but not limited to, the field of facial recognition. Facial recognition may include matching a machine received facial image of a person (e.g., a digital and/or analog) with some form of database to facilitate a match (i.e., facial recognition of the person).

A facial recognition system having a relatively small number of image capture devices (e.g., 1 or 2 cameras, still and/or video) with a relatively small database (e.g., having hundreds or a thousand embeddings) may be capable of searching the database and finding a match in a relatively short period of time (i.e., may be referred to as “real time”). Facial recognition systems having relatively small image capture devices and databases may be facilitated by a wide range of computing systems. However, when the facial recognition system includes a large number of image capture devices with a relatively large database (e.g., hundreds of thousands to millions, billions) the processing and management of data to facilitate facial recognition may take more time than what may be considered real time. For example, the processing and management of data to facilitate facial recognition may take numerous seconds to minutes. Having facial recognition takes numerous seconds to minutes may not be preferable for various applications.

An example of an application, which facial recognition taking a relatively long time may be undesirable, may be security related application. For example, an establishment such as, but not limited to, a transportation hub, a venue, a store, a casino, etc., may prefer to process and manage facial recognition relatively quickly. In one example, at a transportation hub (e.g., airport), relatively slow facial recognition may be detrimental in preventing certain nefarious activities, which may involve safety of people. In another example, a casino may have banned a particular person from the premises. However, the banned person may attempt to enter the casino. It would be preferable for the casino to recognize the person at the earliest opportunity (e.g., at an entry point and/or close to an entry point).

All subject matter discussed in this section of this document is not necessarily prior art and may not be presumed to be prior art simply because it is presented in this section. Plus, any reference to any prior art in this description is not and should not be taken as an acknowledgement or any form of suggestion that such prior art forms parts of the common general knowledge in any art in any country. Along these lines, any recognition of problems in the prior art are discussed in this section or associated with such subject matter should not be treated as prior art, unless expressly stated to be prior art. Rather, the discussion of any subject matter in this section should be treated as part of the approach taken towards the particular problem by the inventor(s). This approach in and of itself may also be inventive. Accordingly, the foregoing summary is illustrative only and not intended to be in any way limiting. In addition to the illustrative aspects, embodiments, and features described above, further aspects, embodiments, and features will become apparent by reference to the drawings and the following detailed description.

### SUMMARY

Described herein are various illustrative methods, systems, and apparatus for facilitating machine learning of processing and management of biometric matching.

Some example systems may include a processor, a storage medium, and a biometric matching module (BMM). In one example, the BMM may be configured to machine learn processing and management of facial recognition. In another example, the BMM may be configured to allocate a large contiguous memory space or pool to facilitate machine learn processing and management of facial recognition.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates a block diagram of a system for facilitating machine learning of processing and management of biometric matching.

FIG. 2 illustrates an example of image capture devices identifying and confirming an identity of a person in accordance with various embodiments.

FIG. 3 illustrates a block diagram of multiples in performance for processors, in accordance with various embodiments.

FIG. 4 illustrates an operation flow of the various embodiments disclosed herein.

FIG. 5 illustrates a computer program product in accordance with various embodiments.

FIG. 6 is a block diagram illustrating an example computing device, such as might be embodied by a person skilled in the art, which is arranged in accordance with at least some embodiments of the present disclosure.

### DETAILED DESCRIPTION

The following description sets forth various examples along with specific details to provide a thorough understanding of claimed subject matter. It will be understood by those skilled in the art after review and understanding of the present disclosure, however, that claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, systems, and apparatus for facilitating machine learning of processing and management of biometric matching.

Prior to turning to the figures, some non-limiting example scenarios may be described to more fully understand the claimed subject matter. For example, some non-limiting example scenarios illustrating the utilization and implementation of the various embodiments of the present disclosure may be described.

In one non-limiting example scenario, biometric processing may utilize various machine learning methodologies such as, but not limited to, artificial intelligence (AI). For example, a processing machine having AI capabilities may be configured to utilize neural networks to facilitate the processing of biometric data such as, but not limited to, facial recognition. In this example, an image of the face of a person may be captured by an image capture device, such as, but not limited to, a surveillance camera. The AI machine may receive a digital representation of an analog input of the image of the face, where the digital representation may include audio waveform (e.g., pulse-code modulation or PCM) and/or images (e.g., RGB pixels). In this non-limiting example of the AI machine utilizing neural networks, an output may be a fixed array of numbers and may be referred to as an embedding. Some examples of the fixed array of number may include, but not limited to, lengths of 128, 256, 512, and so forth.

In the non-limiting example scenario of facial recognition, a fixed sized pixel buffer including an image of the face may be processed by the AI machine and a resulting embedding may be considered to be biometric data, which may be utilized to be compared with other embeddings. For example, the AI machine may be configured to compare a similarity between two embeddings, where if the similarity between the two embeddings substantially meets a predetermined level, a determination may be made that the probability of a facial recognition may be high (e.g., same face).

The comparing of embeddings may be performed utilizing various algorithms such as, but not limited to, distance algorithms (e.g., Euclidean Distance or Cosine Similarity). In the case utilizing Euclidean Distance algorithm, two embeddings of the same array size may be compared, where the distance between the two embeddings may indicate a level of difference between the two embeddings. For example, a distance of 0 may indicate that the two embeddings may be substantially the same (i.e., a match).

In some examples, facial recognition systems having AI utilizing neural networks, photographs of faces may be inputted into the system. The inputted photographs of faces may be processed, and the embeddings may be stored in a database, which may or may not include metadata such as, but not limited to, a name of the person, color of their eyes, color of their hair, etc. During the facial recognition process, the embeddings from an inputted image (e.g., a camera) may be extracted. The embeddings may be compared to substantially all of the embeddings in the database to determine if a comparison substantially meets the predetermined threshold as a match.

Continuing with non-limiting scenario of facial recognition of a large number of image captures devices and persons, in order to facilitate substantially real time matching in this scenarios that may have a high rate of matching requests against a database of hundreds, of thousands, of millions, or of billions of embeddings, the embeddings may be loaded into a data structure that may be configured to optimize the functionality of a processor and/or a computer hardware architecture, in accordance with various embodiments. For example, a processor may be configured to not directly process data that may be in random access memory (RAM), but instead, may be configured to transfer data in the RAM to a cache memory of the processor to be processed. In this example, if data to be processed is not available in the cache memory, the data may be transferred from the RAM (i.e., a cache miss), which may result in some latency (i.e., relatively slower processing). Accordingly, when a core task may be to process a large amount of data (e.g., facial recognition as described herein), storing data in a contiguous memory space may increase the likelihood of the large amount of data being loaded in the cache memory of the processor in accordance various embodiments.

In one example, in order to facilitate optimization of the performance of finding a match, a large contiguous memory space, or pool may be allocated. The large contiguous memory space may be defined as holding fixed sized records. Each record may store a fixed size embedding such as, but not limited to, 128, 256, 512 and so forth array of numbers, which may include a fixed length metadata. As described, the metadata may include an identifier, which may exist in another data store as a reference to other information on the embedding such as, but not limited to, the identity of the face (i.e., the person to whom the face belongs) or pixel images of the face of the person.

When a search for a match is requested, substantially the entire record pool may be enumerated over, comparing the input embedding with the stored embedding. If a match meets the criteria (e.g., substantially meets a predetermined confidence threshold), the record's reference may be returned with the result facilitating the use of the identifier stored in the record to look up further information for another data store by a caller (e.g., user).

In order to facilitate an increase in the performance of the biometric matching, the enumeration over the record pool may be divided among one or more processor cores, which may result in substantially the entirety of the pool being processed concurrently. For example, on a 2-core processor with a record pool of a million items, processor core 1 may process records 1-1000, processor core 2 may process records 1001-2000, and so forth, until substantially all of the records are processed, where a single result may be produced.

In another example, in order to facilitate optimization of the performance of finding a match a comparison algorithm may be configured to utilize parallel processing methodologies such as, but not limited to, single instruction, multiple data (SMID) methodology. The SMID approach may facilitate the processing of multiple pieces of data at substantially at the same time (i.e., in one processor operation). Because in one example, the embeddings may be an array of numbers with the Euclidean Distance methodology being operated on the array of numbers, the SMID approach may be well utilized.

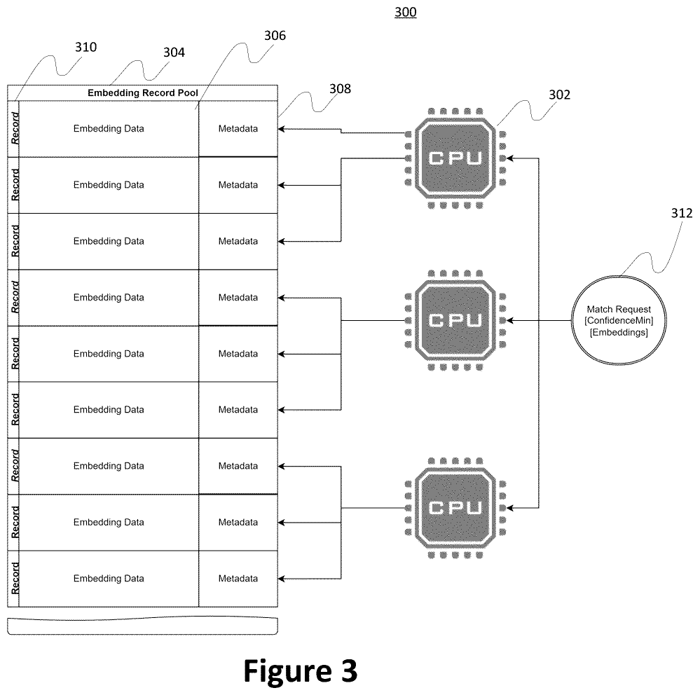

In yet another example, in order to facilitate optimization of the performance of finding a match, an approach of batching of facial match requests may be utilized. In this example, facial recognition systems may receive numerous match requests substantially simultaneously. For example, numerous match requests substantially simultaneously may be received when numerous faces may be detected substantially simultaneously from a number of image capture devices (e.g., cameras). Accordingly, instead of processing the substantially simultaneously match requests serially, the BMM may be configured to process the match requests substantially at the same time (e.g., concurrently and/or in parallel). For example, given match_request_a(input_embedding) and match_request_b(input_embedding), a comparison may be made for each record in the pool with match_request_a's embedding, and subsequently match_request_b's embedding. This example may provide multiples in performance as each embedding (e.g., three processors shown in FIG. 3) may be in the cache memory of the processor.

It should be appreciated by one of ordinary skilled in the relevant art that the processor and/or processor described herein may include a wide variety of processors such as, but not limited to, processors capable of implementing machine learning/recognition methodologies including machine learning methodologies having AI capabilities to facilitate at least some of the functionality described herein. For example, a processor and/or processors may be AI capable processors available from Intel Corporation of Santa Clara, California (e.g., Nervana™ type processors), available from Nvidia Corporation of Santa Clara, California (e.g., Volta™ type processors), available from Apple Company of Cupertino, California (e.g., A11 Bionic™ type processors), available from Huawei Technologies Company of Shenzen, Guangdong, China (e.g., Kirin™ type processors), available from Advanced Micro Devices, Inc. of Sunnyvale, California (e.g., Radeon Instinct™ type processors), available from Samsung of Seoul, South Korea (e.g., Exynos™ type processors), and so forth. Accordingly, the claimed subject matter is not limited in these respects. The utilization of machine learning may facilitate machine learning of processing and managing biometric data as described herein.

Biometric identification/matching may include a unique “signature” of a feature of an individual such as, but not limited to, a face of the individual. As previously described, the data related to the face of the individual may be described by a relatively large list of numbers, which may be processed and managed (e.g., by the BMM). However, in order to further describe the various embodiments, another non-limiting example scenario may be described utilizing an analogy between biometric matching with a matching with relatively smaller numbers such as, but not limited to, a location on earth (i.e., coordinates having two number representing longitude and latitude).

In this non-limiting example, when trying to determine the closest existing match(es) to a new biometric signature, a mathematical “distance” may be calculated and evaluated between the new “input” biometric data and substantially the entire collection of existing biometric data, which may be in the process of being compared. Utilizing the analogy of the location on earth, determining the closest existing match may be analogized as comparing a new input location (e.g., longitude and latitude) against a large collection of known locations (e.g., a number of establishments such as, but not limited to, a restaurant chain). In this example, distances from each of the locations of the restaurants may be calculated to determine if one or more restaurants may be considered to be within reasonable driving distance.

As may be appreciated, since biometric data may be described by a substantially larger list of numbers (e.g., hundreds, thousands, millions, and so forth) the calculation and determination of these distances against some new input data received may be relatively more computationally intensive. Some evaluation methods for biometric matching utilizing databases, where the databases may have stored biometric data, may struggle with sub-second evaluation on collection sizes approaching 1 million records irrespective of the evaluation methods utilizing relatively powerful and modern systems. These evaluation methods may make real-time matching slow and/or difficult on relatively very large biometric comparison sets with millions of records (e.g., under load conditions).

Accordingly, in some embodiments, the following methodology may be described:
Pre-loading and densely packing substantially the entire biometric data collection into system memory in an optimized structure.
Batch processing the distance calculations for a given pass against a dynamic number of input values based, at least in part on, a variable time window to optimize speed under load, which may be by reducing the cost associated with transferring data from memory to processor cache, where the data may be processed.
Dividing the computational comparison duties across substantially all of the available processing units (e.g., processors, CPU cores, GPU cores, etc.) and utilizing various applicable hardware acceleration techniques.
Coalescing the results for the (e.g., potentially) multiple inputs across substantially all of the operating processing.

Turning back to the analogy of the locations of restaurants, the described herein methodology may be described as follows:
Loading up substantially the entire collection of 1000 restaurant locations (e.g., longitude, latitude, name, etc.) into memory in a dense, organized, and optimized manner.
As an example, 3 people/users may have requested for a determination of the closest drivable location to themselves in the last 1 second, and accordingly, calculations for all 3 inputs during the same pass through our restaurant data thus we will process calculations for all 3 inputs during the same pass through our restaurant data may be processed.
As an example, utilizing a computing system having 10 CPU cores, the 1000 restaurant locations may be divided to facilitate that each of the CPU cores may be utilized to perform the calculations for 100 restaurant locations (e.g., 1/10^{th}) against the 3 received user input locations currently being processed, which may include mathematical computational capabilities of the CPU.
After determining if any restaurant locations meet the distance threshold to be considered within driving distance, evaluating the distance calculations across the different CPU cores and returning results for each of the 3 user input locations.

As a result, biometric matching utilizing substantially large data sets having thousands, millions, to billions of biometric records may provide results in a relatively short period of time (e.g., seconds to milliseconds).

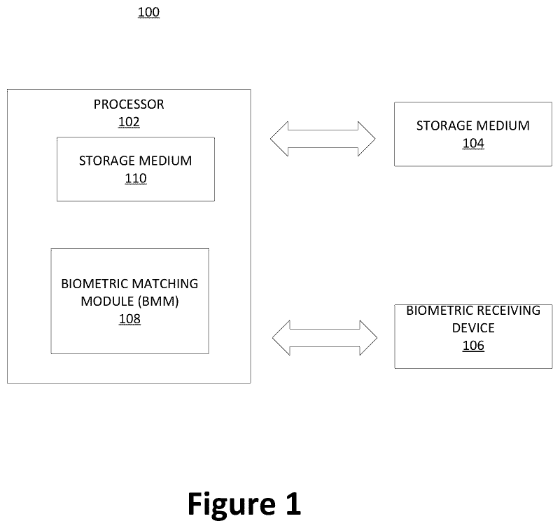

Turning now to FIG. 1, FIG. 1 illustrates a block diagram of system for facilitating machine learning of processing and management of biometric matching. In FIG. 1, a system 100 may include a processor 102, a first storage medium 104, and a biometric receiving device (BRD 106). As shown in FIG. 1, the processor 102 may include a biometric matching module (BMM) 108 and a second storage medium 110. As shown in FIG. 1, the second storage medium 110 may be included in the processor 102.

In the system 100 shown in FIG. 1, the first storage medium 104 and the BRD 106 may be communicatively coupled with the processor 102. The BRD 106 may be a variety of devices capable of receiving biometric information such as, but not limited to, an image capture device (e.g., video camera). Additionally, in FIG. 1, a single BRD 106 may be shown, but it should be appreciated that the system may include a wide number of BRDs. Accordingly, the claimed subject matter is not limited in this respect.

In FIG. 1, under the control of the processor 102, the BMM 108 may be configured to receive digital biometric data (e.g., facial data). Responsive to receiving the digital biometric data, the BMM 108 may be configured to convert the digital biometric data into a first embedding. Subsequent to converting the digital biometric data, the BMM 108 may be configured to cause to move a second embedding from the first storage medium 104 to the second storage medium 110. In FIG. 1, the first storage medium 104 may be a different configuration than the second storage medium 110. For example, the first storage medium 104 may be of a non-volatile type (e.g., a hard drive), while the second storage medium may be of a volatile type (e.g., random access memory and/or cache type memory). For example, the BMM 108 may cause to move the second embedding from a hard drive to a cache prior to processing, in accordance with various embodiments.

Once the second embedding has been moved to a storage medium that is closer and/or included in the processor 102, the BMM 108 may determine if the first embedding substantially matches the second embedding. The determination may be performed by a variety of methodologies such as, but not limited to, distance algorithm methodologies. For example, if it is determined that the Euclidean distance between each pair of embeddings from the two sets have the smallest Euclidean distances, the embeddings may be considered to be substantially a match.

It should be appreciated that embeddings, as referred herein, may include a variety of digital data management approaches such as, but not limited to an approach, which may include a process of representing data in a lower-dimensional space, while preserving various characteristics or relationships of the original data. For example, the process of representing data in a lower-dimensional space may include process(es) that may be utilized in various fields such as, but not limited to, natural language processing (NLP), computer vision, and/or recommender systems.

In one example, the system 100 may be part of and/or included in a neural network. Accordingly, the BMM 108 may be configured to convert the first embedding using the neural network, in accordance with various embodiments. For example, the digital data may be converted into a fixed array of numbers utilizing the neural network.

In another example, the BMM 108 may be configured to cause the second embedding to move from the first storage medium 104 to a record pool prior to the matching determination. For example, the matching may be determined by enumerating over the record pool.

As shown in FIG. 1, the processor 102 having the BMM 108 may be communicatively coupled with the various components (e.g., the first storage medium 104 and/or the BRD 106). However, in one example, the BMM 108 may be included in a processor that may be communicatively coupled with the various components wirelessly. For example, the BMM 108 may be included in a personal communication device such as, but not limited to, a smartphone. The smartphone may be communicatively coupled with the system 100 wirelessly. The wireless communications may include a wide variety of wireless communication approaches such as, but not limited to, Bluetooth, Near Field Communication (NFC), WiFi, low power wireless communication (e.g., Zigbee), and so forth. Accordingly, the claimed subject matter is not limited in this respect.

In FIG. 1, the various components of the system 100 may be arranged in a variety of manners. Additionally, the system 100 may include a wide variety of combinations of the components including omitting some of the components in accordance with various embodiments.

As a result, machine learning of processing and management of biometric matching may be facilitated, in accordance with various embodiments.

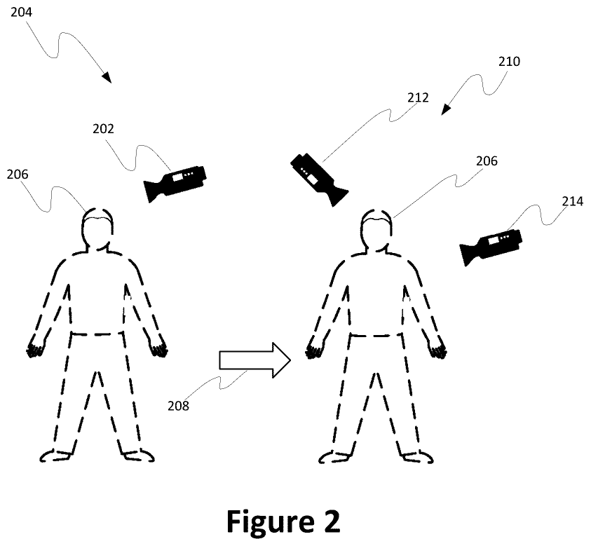

FIG. 2 illustrates an example of image capture devices identifying and confirming an identity of a person in accordance with various embodiments. In FIG. 2, a first image capture device 202 may be located in a first location 204. A facial image of a person 206 may be received by the first image capture device 202 located at the first location 204. From the received facial image of the person 206, an identity of the person 206 may be confirmed. The data associated with the identity of the person 206 may be converted into an embedding and stored in a storage medium, which may be a non-volatile type memory (e.g., hard drive, cloud, flash memory, etc.).

As shown in FIG. 2, the person 206, whose identity may have been confirmed, may have moved 208 to a second location 210. In FIG. 2, the second location 210 may include one or more image capture devices 212 and 214. For the purposes of describing the claimed subject matter, references may be made to one of the image capture devices (e.g., image capture device 212). In the second location 210, a second image capture device 212 may capture the image/video of the person 206. The image/video of the person 206 may be converted to digital information and received by a BMM. The BMM may convert the received digital information into an embedding. The embedding may be utilized to determine if the captured image/video of the person 206 (i.e., the embedding) substantially matches the stored embedding, in accordance with various embodiments.

In FIG. 2, it should be appreciated that the biometric matching of may involve numerous people, in accordance with various embodiments. Additionally, the captured image/video of the person 206 may be an analog type of information. Accordingly, the analog type of information may be converted to a digital type of information, which may be processed by a machine learning device/system. As described, the digital information may be in the form of an embedding, which may be stored. The embedding may include a variety of data such as, but not limited to, various metadata, which may correspond to data to facilitate recognition of the person 206.

FIG. 3 illustrates a block diagram of multiples in performance for processors, in accordance with various embodiments. In FIG. 3, a machine learning system 300 may include one or more processors 302. The one or more processors 302 may be mapped to an embedding record pool 304. The embedding record pool 304 may include one or more embedding data 306. Additionally, the embedding record pool 304 may include one or more metadata 308 and one or more record 310. As shown, a match request 312 may be received by the machine learning system 300. For example, the match request 312 may be communicated to the one or more processors 302. The one or more processors 302 may communicatively coupled with the embedding record pool 304. As a result, numerous match requests 312 may be processed and determined in substantially real-time and/or relatively a short period of time, in accordance with various embodiments.

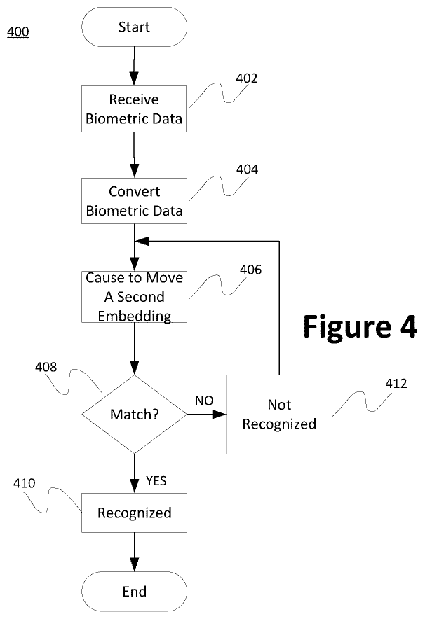

FIG. 4 illustrates an operation flow of the various embodiments disclosed herein. FIG. 4 illustrates an operational flow for facilitating machine learning of processing and management of biometric matching, in accordance with various embodiments as described herein. In some portions of the description, illustrative implementations of the method are described with reference to the elements depicted in FIGS. 1-4. However, the described embodiments are not limited to these depictions.

Additionally, FIG. 4 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of the claimed subject matter.

In some examples, operational flow 400 may be employed as part of a system for facilitating machine learning of processing and management of biometric matching as described herein. Beginning at block 402 (“Receive Biometric Data”), at a biometric matching module (BMM), a digital biometric data from a biometric receiving device may be received.

Continuing from block 402 to block 404 (“Convert Biometric Data”), the digital biometric data may be converted into a first embedding.

Continuing from block 404 to block 406 (“Cause to Move a Second Embedding”), a second embedding may be moved from a first storage medium to a second storage medium, where the second storage medium having a different storage configuration than the first storage medium and being closer to a processor.

Continuing from block 406 to decision diamond 408 (“Match?”), it may be determined if the first embedding substantially matches the second embedding.

If the first embedding doe substantially match the second embedding (e.g., distance algorithm), a person may be recognized 410.

If the first embedding does not substantially match the second embedding, the person may not be recognized 412. Additionally, and/or alternatively, more stored embeddings may be moved to determine if any other embeddings may be a match (i.e., one or more iterations), in accordance with some embodiments.

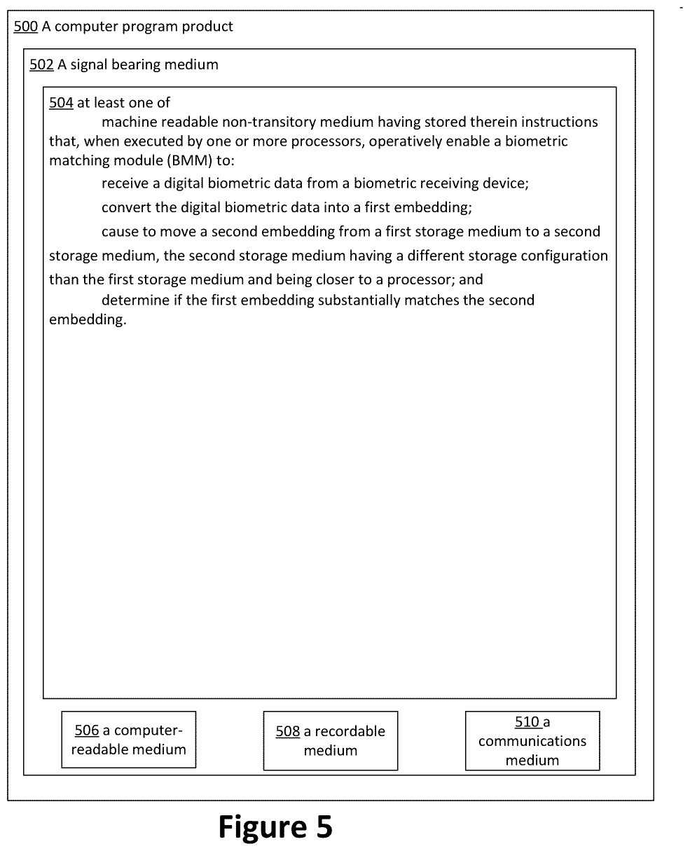

In general, the operational flow described with respect to FIG. 4 and elsewhere herein may be implemented as a computer program product, executable on any suitable computing system, or the like. For example, a computer program product for facilitating machine learning of processing and management of biometric matching may be provided. Example computer program products may be described with respect to FIG. 5 and elsewhere herein.

FIG. 5 illustrates a computer program product in accordance with various embodiments. FIG. 5 illustrates an example computer program product 500, arranged in accordance with at least some embodiments described herein. Computer program product 500 may include machine readable non-transitory medium having stored therein instructions that, when executed, cause the machine to facilitate machine learning of processing and management of biometric matching according to the processes and methods discussed herein. Computer program product 500 may include a signal bearing medium 502. Signal bearing medium 502 may include one or more machine-readable instructions 504 which, when executed by one or more processors, may operatively enable a computing device to provide the functionality described herein. In various examples, the devices discussed herein may use some or all of the machine-readable instructions.

In some examples, the machine-readable instructions 504 may include a biometric matching module (BMM). In some examples, the machine readable medium 504 may facilitate the BMM to receive a digital biometric data from a biometric receiving device.

In some examples, the machine readable medium 504 may convert the digital biometric data into a first embedding.

In some examples, the machine readable medium 504 may cause to move a second embedding from a first storage medium to a second storage medium, where the second storage medium having a different storage configuration than the first storage medium and being closer to a processor.

In some examples, the machine readable medium 504 may determine if the first embedding substantially matches the second embedding.

In some implementations, signal bearing medium 502 may encompass a computer-readable medium 506, such as, but not limited to, a hard disk drive, a Compact Disc (CD), a Digital Versatile Disk (DVD), a Universal Serial Bus (USB) drive, a digital tape, memory, etc. In some implementations, the signal bearing medium 502 may encompass a recordable medium 508, such as, but not limited to, memory, read/write (R/W) CDs, R/W DVDs, etc. In some implementations, the signal bearing medium 502 may encompass a communications medium 510, such as, but not limited to, a digital and/or an analog communication medium (e.g., a fiber optic cable, a waveguide, a wired communication link, a wireless communication link, etc.). In some examples, the signal bearing medium 502 may encompass a machine readable non-transitory medium.

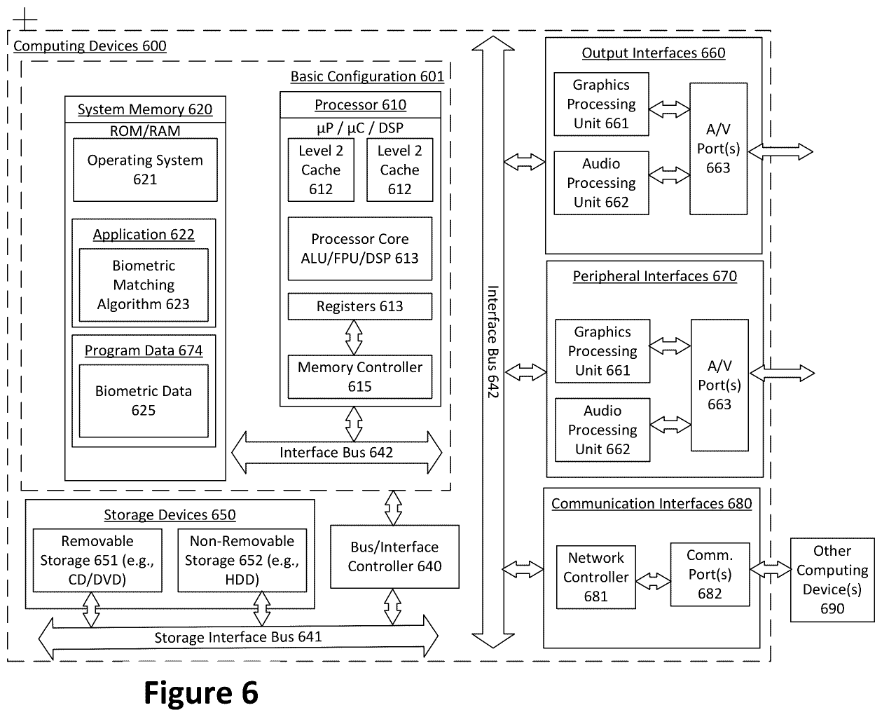

In general, the methods described with respect to FIG. 5 and elsewhere herein may be implemented in any suitable computing system. Example systems may be described with respect to FIG. 6 and elsewhere herein. In general, the system may be configured to facilitate a biometric matching module (BMM), in accordance with various embodiments.

FIG. 6 is a block diagram illustrating an example computing device 600, such as might be embodied by a person skilled in the art, which is arranged in accordance with at least some embodiments of the present disclosure. In one example configuration 601, computing device 600 may include one or more processors 610 and system memory 620. A memory bus 630 may be used for communicating between the processor 610 and the system memory 620.

Depending on the desired configuration, processor 610 may be of any type including but not limited to a microprocessor (μP), a microcontroller (μC), a digital signal processor (DSP), a graphics processing unit (GPU), a processing unit utilizing reduced instruction set computer (RISC) architecture, and/or any combination thereof. Processor 610 may include one or more levels of caching, such as a level one cache 611 and a level two cache 612, a processor core 613, and registers 614. The processor core 613 may include an arithmetic logic unit (ALU), a floating point unit (FPU), a digital signal processing core (DSP Core), or any combination thereof. A memory controller 615 may also be used with the processor 610, or in some implementations the memory controller 615 may be an internal part of the processor 610.

Depending on the desired configuration, the system memory 620 may be of any type including but not limited to volatile memory (such as RAM), non-volatile memory (such as ROM, flash memory, etc.) or any combination thereof. System memory 620 may include an operating system 621, one or more applications 622, and program data 624. Application 622 may include biometric matching module (BMM) 623 that is arranged to perform the functions as described herein including the functional blocks and/or actions described. Program Data 624 may include types of biometric data 625 (e.g., embeddings) for use with BMM 523. In some example embodiments, application 622 may be arranged to operate with program data 624 on an operating system 621 such that implementations of facilitating BMM configured to machine learn biometric matching as described herein. For example, apparatus described in the present disclosure may comprise all or a portion of computing device 600 and be capable of performing all or a portion of application 622 such that implementations of facilitating communication module configured to determine biometric matching may be provided as described herein. This described basic configuration is illustrated in FIG. 5 by those components within dashed line 601.

Computing device 600 may have additional features or functionality, and additional interfaces to facilitate communications between the basic configuration 601 and any required devices and interfaces. For example, a bus/interface controller 640 may be used to facilitate communications between the basic configuration 601 and one or more data storage devices 650 via a storage interface bus 641. The data storage devices 650 may be removable storage devices 651, non-removable storage devices 652, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable, and non-removable media implemented in any method or technology for storage of information, such as computer readable instructions, data structures, program modules, or other data.

System memory 620, removable storage 651 and non-removable storage 652 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of device 600.

Computing device 600 may also include an interface bus 642 for facilitating communication from various interface devices (e.g., output interfaces, peripheral interfaces, and communication interfaces) to the basic configuration 601 via the bus/interface controller 640. Example output interfaces 660 may include a graphics processing unit 661 and an audio processing unit 662, which may be configured to communicate to various external devices such as a display or speakers via one or more A/V ports 663. Example peripheral interfaces 660 may include a serial interface controller 671 or a parallel interface controller 672, which may be configured to communicate with external devices such as input devices (e.g., keyboard, mouse, pen, voice input device, touch input device, etc.) or other peripheral devices (e.g., printer, scanner, etc.) via one or more I/O ports 673. An example communication interface 680 includes a network controller 681, which may be arranged to facilitate communications with one or more other computing devices 690 over a network communication via one or more communication ports 682. A communication connection is one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. In addition, computing device 600 may be implemented as part of a wireless base station or other wireless system or device.

It should be appreciated after review of this disclosure that it is contemplated within the scope and spirit of the present disclosure that the claimed subject matter may include a wide variety of routers, modems, computing devices, communication mediums/approaches, etc. Accordingly, the claimed subject matter is not limited in these respects.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter is not limited to the particular examples disclosed, but that such claimed subject matter also may include all implementations falling within the scope of the appended claims, and equivalents thereof.

What is claimed is:

1. A method of machine learning for management of biometric data, the method comprising:
receiving, by a computing device, a digital biometric data from a biometric receiving device;
converting the digital biometric data into a first embedding;
causing to move a second embedding from a first storage medium to a second storage medium, the second storage medium having a different storage configuration than the first storage medium and being closer to a processor; and
determining if the first embedding substantially matches the second embedding.

2. The method of claim 1, wherein receiving the digital biometric data comprises receiving the biometric data from an image capture device.

3. The method of claim 1, wherein converting the digital biometric data into the first embedding comprises converting the digital representation using a neural network.

4. The method of claim 3, wherein converting the digital biometric data using the neural network comprises converting the digital representation into a fixed array of numbers.

5. The method of claim 1, wherein causing to move comprises causing to move the second embedding from non-volatile memory to volatile memory.

6. The method of claim 5 further comprising causing to move the second embedding from volatile memory to cache memory.

7. The method of claim 1, wherein determining comprises determining if the first embedding substantially matches the second embedding using distance matching.

8. The method of claim 7, wherein using the distance matching comprises using Euclidean Distance Matching.

9. The method of claim 1, wherein causing to move the second embedding from the first storage medium to the second storage medium comprises causing to move the second embedding to a record pool.

10. The method of claim 9, wherein determining if the first embedding substantially matched the second embedding comprises enumerating over the record pool.
